(19) United States
(12) Patent Application Publication
(10) Pub. No.: US 2008/0137098 A1
(43) Pub. Date: Jun. 12, 2008

(54) METHOD OF MULTIPLE WAVELENGTH INTERFEROMETRY

(76) Inventor: Michael J. Mater, Chelsea, MI (US)

Correspondence Address: SCHOX PLC, 730 Florida Street #2, San Francisco, CA, 94110, US

(21) Appl. No.: 11/949,205

(22) Filed: Dec. 3, 2007

Related U.S. Application Data
(63) Continuation-in-part of application No. 10/349,651, filed on Jan. 23, 2003, now Pat. No. 7,317,541.
(60) Provisional application No. 60/351,730, filed on Jan. 25, 2002.

(51) Int. Cl. G01B 9/02

(52) U.S. Cl. 356/512

(57) ABSTRACT

A method for creating an image of an object includes setting an illumination source at an initial nominal wavelength, illuminating an object with an illumination source to create interference patterns, changing the wavelength of the illumination source to drift from the nominal wavelength to a drift wavelength over a time period that causes a 360° shift in the phase angle of the interference patterns, sampling the interference patterns multiple times during the time period, reconstructing the phase angle of several points on the object, and creating an image of the object based on the sampled and reconstructed information.

### CROSS-REFERENCE TO RELATED APPLICATIONS

This application is a continuation-in-part of prior application Ser. No. 10/349,651, filed 23 Jan. 2003, entitled “Interferometry Method based on Changing Frequency”, which claims the benefit of U.S. Provisional Application No. 60/351,730 filed 25 Jan. 2002, entitled “Interferometer with Measurement Correction Based on Phase Change.” Both applications are incorporated in their entirety by this reference.

### TECHNICAL FIELD

This invention relates generally to the interferometry field, and more specifically to a new and useful method of multiple wavelength interferometry in the interferometry field.

### BACKGROUND

Multiple-wavelength interferometer systems typically include a tunable laser to achieve their multi-wavelength performance. Many suitable types of tunable lasers exist, and examples include dye, titanium sapphire, Alexandrite, distributed feedback diode, distributed Bragg reflection diode, and external cavity diode. At present, the tunable diode lasers are the most cost effective in commercial applications. Unfortunately, the wavelength output of diode lasers varies as a function of temperature and forward current (and other parameters). Modern electronic control circuitry is unable to adequately regulate the temperature and forward current (and other parameters) to stabilize the laser so that the wavelength does not drift or jitter. For example, external cavity tunable lasers depend on the electromechanical movement of the external cavity, which sometimes contains a grating and/or a mirror. There is a tendency for these systems to drift and jitter in wavelength as the electronic control attempts to stabilize the laser by modifying the temperature, forward current, and position of the grating.

Interferometers are sufficiently sensitive so that wavelength variation on the order of one hundred (100) picometers or less can translate into potential phase error in an unequal path length interferometer. Accordingly, multiple-wavelength interferometers and laser radar systems utilizing such lasers have resulted in less than desirable performance due to laser drift and jitter. Thus, there is a need in the interferometry field to create a new and useful method of multiple wavelength interferometry. This invention provides such a new and useful method.

### BRIEF DESCRIPTION OF THE FIGURES

FIG. 1 is a schematic representation of an interferometer 10 having unequal path lengths suitable for use in conjunction with the preferred method of the invention.

FIGS. 2A and 2B together are examples of interference pattern frames captured for a given nominal wavelength using the preferred method of the invention.

FIG. 3 is a flow chart representing the preferred method 30 of the invention.

### DESCRIPTION OF THE PREFERRED EMBODIMENTS

The following description of the preferred embodiments of the invention is not intended to limit the invention to these preferred embodiments, but rather to enable any person skilled in the art to make and use this invention.

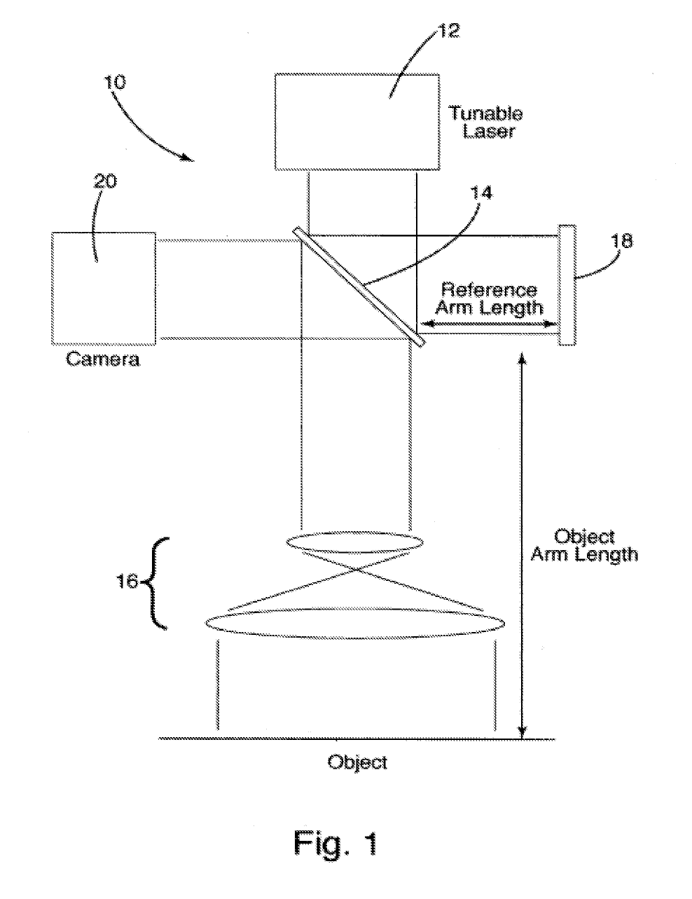

The method of the invention can be used in conjunction with a wide variety of interferometers. The method is particularly suited to unequal path length interferometers such as Twyman Green, Michelson, Fizeau, Fabry Perot, and Mach Zender. As shown in FIG. 1, the exemplary interferometer 10 is a Michelson interferometer, in which the object arm path length is much longer than the reference arm path length. The Michelson interferometer 10 includes a tunable laser 12, a beam splitter 14, an optics assembly 16, a reference mirror 18, and a camera 20. The interferometer 10 further includes a piezo (not shown) for moving the reference mirror 18 to produce a desired phase shift. By using multiple wavelengths and capturing n phases (preferably four phases at 0, 90, 180, and 270 degrees) of data at each wavelength, the object surface height can be reconstructed.

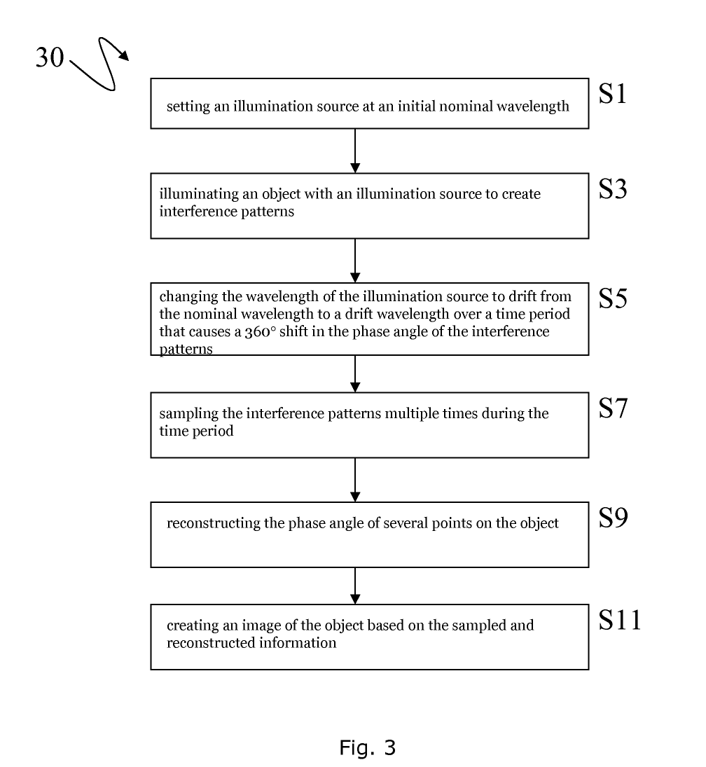

As shown in FIG. 3, a method 30 for creating an image of an object includes setting an illumination source at an initial nominal wavelength S1, illuminating an object with an illumination source to create interference patterns S3, changing the wavelength of the illumination source to drift from the nominal wavelength to a drift wavelength over a time period that causes a 360° shift in the phase angle of the interference patterns S5, sampling the interference patterns multiple times during the time period S7, reconstructing the phase angle of several points on the object S9, and creating an image of the object based on the sampled and reconstructed information S11.

Step S1, which recites setting an illumination source at an initial nominal wavelength, functions to set the initial wavelength of an illumination source for an interferometer. The illumination source is preferably a diode laser, more preferably a New Focus Model 6316 diode laser. The New Focus Model 6316 diode laser has a tunable range of 827 nanometers to 852 nanometers, and the initial wavelength is preferably chosen as 827 nanometers. Further, the preferred embodiment of the invention preferably includes initializing the memory to clear the internal images and other measurement frames that remain from previous measurements. Additionally, the preferred embodiment of the invention has a tunable illumination source that may change wavelengths, such as changing the wavelength 1 nanometer from 827 nanometers to 828 nanometers, or any other change in wavelength that may be possible, either greater than or less than 1 nanometer, with a tunable illumination source such as the diode laser. In one alternative embodiment, the illumination source is a diode laser that is forced to continuously sweep a range of wavelengths. In yet another embodiment, the illumination source is a single wavelength laser diode that changes wavelength, not because it is tuned by a user or a machine, but rather because of fluctuations in the temperature or other environmental conditions.

Step S3, which recites illuminating an object with an illumination source to create interference patterns, functions to illuminate the object with an illumination source to create interference patterns from light reflected from the object using both a reference beam and an object beam.

Step S5, which recites changing the wavelength of the illumination source to drift from the nominal wavelength to a drift wavelength over a time period that causes a 360° shift in the phase angle of the interference patterns, functions to change the wavelength of the illumination source to change from a nominal wavelength to a drift wavelength, and because the interferometer is unbalanced, the resulting change in wavelength appears as a shift in the phase angle of the interference patterns, up to a 360° phase angle shift (one 360 degree phase angle shift would correspond to a drift of one full wavelength). Once the phase angle shifts beyond 360 degrees, the phase angle shift is not detectable. A short delay (e.g. two seconds) is preferably introduced to allow the laser to change to the new wavelength and stabilize at the new wavelength. The wavelength drift is preferably linear with time and/or capture rate, but may have any type of drift function. The drift is also preferably an order of magnitude less than the change in the illumination source wavelength, but the drift may be any suitable amount of drift. The imbalance in the interferometer arm length can be used to calculate the wavelength change and stability during the sweep of the laser. The drift is preferably continuous in a single direction, but may be discontinuous and or drift in multiple directions. The drift is preferably controlled by the user or a machine, but may alternatively be controlled by an other factor, such as temperature.

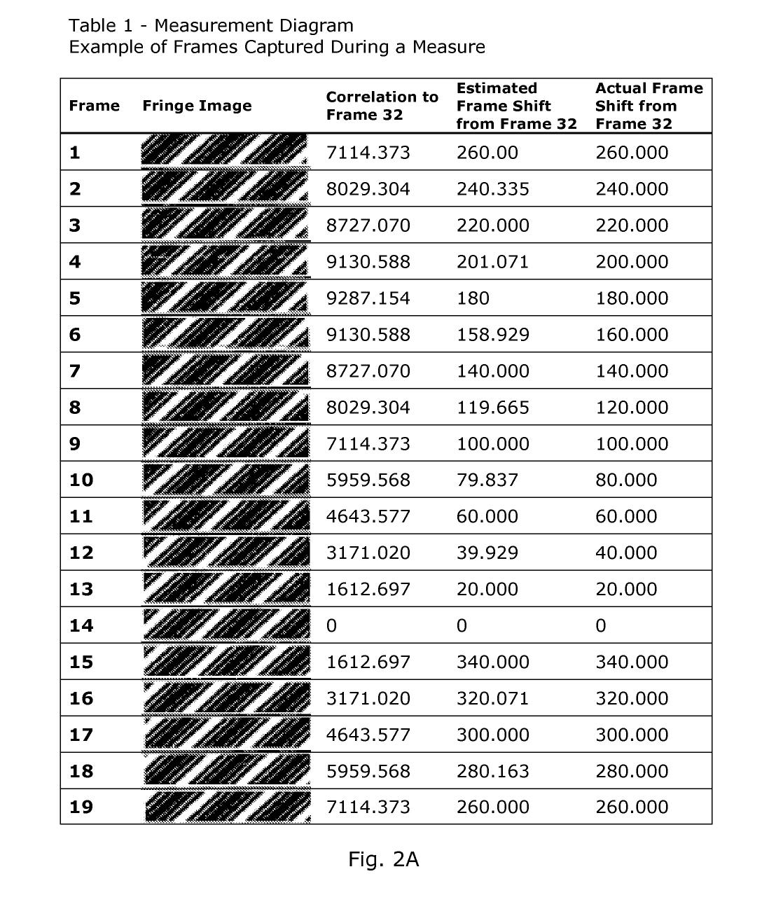

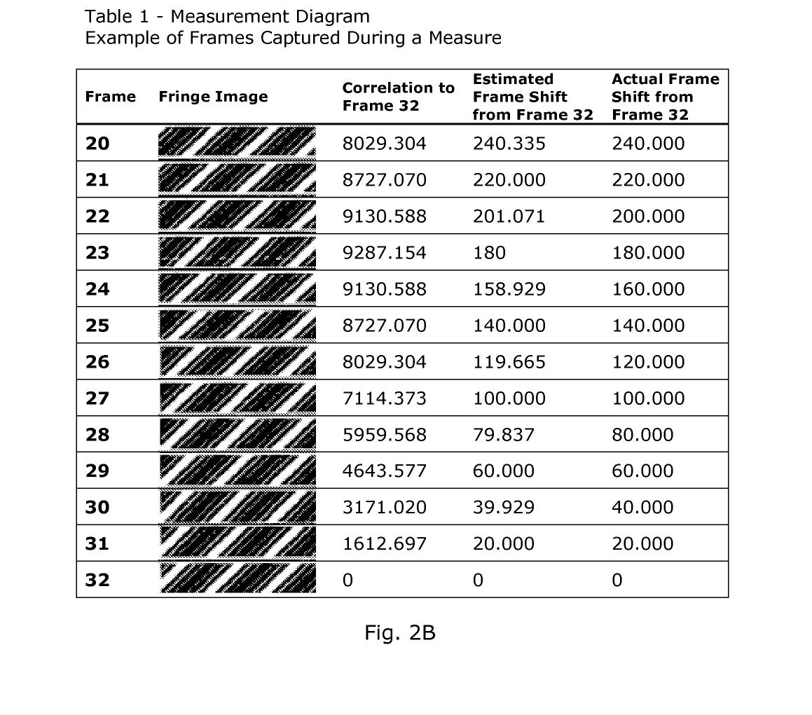

Step S7, which recites sampling the interference patterns multiple times during the time period, functions to sample the interference patterns, preferably at a fast enough rate to capture the drift of the wavelength as it changes from the nominal wavelength, preferably much less than 1 nanometer, more preferably less than 0.001 nanometers or 1 picometer. The captured frames are typically referred to as drift frames, because they are acquired while the illumination source (i.e. laser) is drifting. Thirty-two frames of data are preferably captured, but any suitable number of frames of data may be captured to determine the drift of the illumination source. The drift is preferably slow enough, and/or the sampling rate is preferably fast enough that any sampling device is able to avoid aliasing effects or blurring along the fringes and to avoid causing errors in the phase reconstruction step S9. The interference pattern is preferably at a sampling rate of 18 samples per 360-degree phase shift of the object, where the sampled frames are separated by approximately 20 degrees of phase shift. A sampling rate of approximately an order of magnitude greater than the phase shift of the object is preferably the minimum. In the present embodiment, 32 sampled frames are used as a sample window. As shown in FIGS. 2A and 2B (collectively referred to as FIG. 2), 32 sequential fringe images collected using the method. The second column of FIG. 2, entitled “Correlation to Frame 32” represents the correlation of that frame to an arbitrarily selected reference frame. As shown in FIG. 2, Frame 32, or the “last” frame, has been arbitrarily selected as the reference frame. The correlation between two frames (or a sub area within each frame) is calculated by taking the sum of all of the absolute values of the different frames for each pixel. This methodology is not a mathematical correlation, which is usually a summation of multiplications, but more similar to subtraction. The resulting sum is always positive and removes the offset that varies for each pixel, which allows the correlation to relate to the phase shift with respect to the reference frame. A relatively low value indicates a relatively high correlation, and vice versa. The phase angle of each frame is preferably calculated based on the correlation of that frame to the reference frame. The “Estimated Phase Shift from Frame 32,” the third column of FIG. 2, is preferably calculated using the equation for calculating the phase angle: Angle=180−(acos(Corr/MaxCorr)*360/π. where Corr is the correlation of the frame; and MaxCorr is the frame with the highest (i.e. worst) correlation. The frames that correlate identically (i.e. frames 14 and 32) have a phase shift of zero. The phase shifts of the other frames are approximately 20 degrees separated from one another. Finally, the “Actual Phase Shift from Frame 32,” the fourth column of FIG. 2, is determined by rounding the estimated or calculated phase shift. The preferred method further includes the step of actuating the piezo to shift the mirror 18 so that four additional frames are captured at 0, 90, 180, and 270 degree phase shifts. These frames are referred to as piezo-shift frames because they are acquired while the reference mirror is physically moved by the piezo. If desired, more than four piezo-shift frames can be captured to improve phase accuracy. The 0 and 180-degree piezo-shift frames are preferably calculated, and the go and 270-degree piezo-shift frames are correlated to determine what the peak correlation should be for the drift frames. The last captured drift frame is preferably designated as the reference frame, and the correlation value is preferably calculated for each drift frame on a pixel-by-pixel basis. Summing the absolute value of the pixel differences provides a correlation to the reference frame. This correlation can be performed over the entire field of view or over a subset area of the image, more preferably over the center half of the image. The worst-case correlation in drift frames is preferably compared with the correlation between the piezo-shifted frames to determine whether the laser has drifted enough to cause at least one complete wavelength shift. If such a shift did not occur, only the piezo-shifted frames are used in subsequent processing. In that case, the assumption is that the laser was stable during the drift and therefore was still stable during the piezo-shift as well, and the method will return to Step S5. In one alternative embodiment, the laser may be forced to drift to ensure at least one complete cycle of wavelength drifting, instead of using the piezo-shift method. In another alternative embodiment, the laser may continuously sweep wavelengths to obtain large-ambiguity, high-resolution measurements.

Step S9, which recites reconstructing the phase angle of several points on the object, functions to reconstruct the phase angle. The phase is preferably reconstructed for each pixel, preferably based on the modulation of the drift frames and the piezo-shifted frames. In the preferred embodiment, the conventional 4-bucket algorithm (well-known to those skilled in the art of interferometry) is preferably used in the reconstruction of the phase angle. The frame with the worst correlation is assumed to be 180 degrees out of phase with the reference frame. The frames corresponding to 90 and 270-degree phases are identified as those whose correlations are 0.707 (Cos 45) of the maximum correlation. The two frames (90 and 270 degree frames) can be distinguished because of the continuous drift in the same direction. Using a standard four-bucket phase unwrapping method, the phases of each pixel in each frame are sorted into buckets, enabling the calculation of the complex surface vector at each pixel. Algorithms for phase reconstruction that use more than a four-bucket algorithm may also be used, such as an n-bucket algorithm where all frames within the sweep are utilized. Finally, a check is made to determine whether additional wavelengths are to be sampled. If yes, the program flow returns to step S5. If no, program flow continues to step S11. Steps S5 through S9 are repeated until all wavelengths have been measured.

Step S11, which recites creating an image of the object based on the sampled and reconstructed information, functions to calculate a surface height of the object, using the collected complex information, preferably using a standard synthetic aperture radar (SAR) techniques, well known to those skilled in the art of interferometry.

As a person skilled in the art will recognize from the previous detailed description and from the figures and claims, modifications and changes can be made to the preferred embodiments of the invention without departing from the scope of this invention defined in the following claims.

I claim:

1. A method for creating an image of an object comprising the steps of:
a) setting an illumination source at an initial nominal wavelength;
b) illuminating an object with an illumination source to create interference patterns;
c) changing the wavelength of the illumination source to drift from the nominal wavelength to a drift wavelength over a time period that causes a 360° shift in the phase angle of the interference patterns;
d) sampling the interference patterns multiple times during the time period;
e) reconstructing the phase angle of several points on the object; and
f) creating an image of the object based on the sampled and reconstructed information.

2. The method of claim 1, further comprising the step of setting the illumination source to a second nominal wavelength and repeating steps (b), (c), (d), and (e).

3. The method of claim 2, wherein the difference between the initial nominal wavelength and the second nominal wavelength is about 1 nanometer.

4. The method of claim 1, wherein the illumination source is a tunable laser.

5. The method of claim 1, wherein step (c) includes allowing the wavelength of the illumination source to naturally drift from the nominal wavelength to a drift wavelength.

6. The method of claim 1, wherein the drift between the nominal wavelength and the drift wavelength is less than 1 nanometer.

7. The method of claim 6, wherein the drift between the nominal wavelength and the drift wavelength is about 1 picometer.

8. The method of claim 1, wherein step (d) includes sampling the interference patterns about 18 times during the time period.

9. The method of claim 1, wherein step (d) includes correlating the sampled interference patterns.

10. The method of claim 1, wherein step (e) includes using an n-bucket algorithm to determine the phase angle.

11. The method of claim 1, wherein step (f) includes using a synthetic aperture radar technique.

12. The method of claim 1, further comprising causing an additional shift in the phase angle of the interference patterns, and sampling the interference patterns after the additional shift in the phase angle.

13. The method of claim 12, further comprising moving an object to cause the additional shift in the phase angle of the interference patterns.

14. The method of claim 1, further comprising the step of:
g) using the image of the object.

15. The method of claim 1, further comprising the step of:
g) calculating the surface of the object.

16. A method for creating an image of an object comprising the steps of:
g) setting an illumination source at an initial nominal wavelength;
h) illuminating an object with an illumination source to create interference patterns;
i) allowing the wavelength of the illumination source to drift from the nominal wavelength to a drift wavelength over a time period that causes a 360° shift in the phase angle of the interference patterns;
j) sampling the interference patterns multiple times during the time period;
k) reconstructing the phase angle of several points on the object; and
l) creating an image of the object based on the sampled and reconstructed information.

17. The method of claim 16, wherein the illumination source is a single wavelength laser diode.

18. The method of claim 16, wherein the step of allowing the wavelength of the illumination source to drift includes allowing the wavelength of the illumination source to drift based on a change in an environmental parameter.

19. The method of claim 18, wherein the environmental parameter is temperature.

20. The method of claim 16, wherein step (d) includes sampling the interference patterns about 18 times during the time period.
